(19) United States
(12) Patent Application Publication
(10) Pub. No.: US 2001/0005559 A1
(43) Pub. Date: Jun. 28, 2001

(54) Battery and process for preparing the same

(75) Inventors: Daigo Takemura, Tokyo (JP); Hiroaki Urushibata, Tokyo (JP); Makiko Kise, Tokyo (JP); Shigeru Aihara, Tokyo (JP); Hisashi Shiota, Tokyo (JP); Jun Aragane, Tokyo (JP); Shoji Yoshioka, Tokyo (JP); Takashi Nishimura, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI DENKI KABUSHIKI KAISHA, Tokyo (JP)

(21) Appl. No.: 09/742,075

(22) Filed: Dec. 22, 2000

Related U.S. Application Data
(63) Continuation of application No. PCT/JP98/02861, filed on Jun. 25, 1998.

(51) Int. Cl. H01M 2/34; H01M 4/62

(52) U.S. Cl. 429/62; 29/623.3; 429/212; 429/232

(57) ABSTRACT

A conventional battery has a problem that since a device having PTC function was placed outside the battery or outside the electrode of the battery as a safety device in case of temperature rise due to short-circuit current generated by external short-circuit or the like, a large short-circuit current was generated with temperature rise due to internal short-circuit. And therefore, a temperature of the battery further increases due to exothermic reaction to increase the short-circuit current. Also, there is a problem that structure of the battery become complicated and volume energy density is lowered.

The present invention has been carried out in order to solve the above problems. The battery of the present invention is a battery wherein at least one of a positive electrode (1) and a negative electrode (2) comprises an active material layer (6) containing an active material (8) and an electronically conductive material (9) contacted to the active material (8), and the battery body has an electrolytic layer (3) between the above positive electrode (1) and the negative electrode (2), wherein the electronically conductive material (9) comprises an electrically conductive filler and a resin and resistance thereof can be increased with temperature rise, and wherein the battery body is sealed with the outer can (20) without forming extra space.

### TECHNICAL FIELD

The present invention relates to a battery and a process for preparing the same. Particularly, the present invention relates to a battery which has safety ensured by controlling temperature rise caused by short-circuit or the like, improved battery characteristics such as volume energy density and simplified structure, and to a process for preparing the same.

### BACKGROUND ART

Recently, with development in electronic appliances, high leveling of capacity and output density of a battery used as a power source is being advanced. As a battery which can satisfy these requirements, attention is paid to a lithium ion secondary battery. The lithium ion secondary battery has an advantageous effect that energy density is high, while a sufficient counterplan for safety is required because a non-aqueous electrolytic solution is used.

As a counterplan for safety it has been conventionally suggested to incorporate a safety valve which releases increased internal pressure, or a PTC device which increases resistance in accordance with the heat generated from external short circuit to break an electric current.

For example, as disclosed in Japanese Unexamined Patent Publication No. 328278/1992, there is known a method for attaching a safety valve and a PTC device to the positive electrode cap of a cylindrical battery. However, when the safety valve is operated, water in air may invade into a battery to react with lithium in the negative electrode and there is a fear of an exothermic reaction.

On the other hand, the PTC device successively breaks external short-circuit without causing any troubles. As a safety component running firstly at the emergency of the battery, the PTC device can be designed to run when the battery reaches at least 90° C. due to external short circuit.

FIG. 10 shows an example of a conventional lithium secondary battery having the above-mentioned construction, in which a PTC device is mounted. In the figure, numeral 13 indicates a lead, numeral 14 a PTC device, numeral 15 an electrode, numeral 16 a safety valve, and 17 an outer can. Since such the battery has a construction as shown in the figure, there exist problems as shown below.

That is to say, in the conventional lithium secondary battery as shown in the figure, the PTC device 14 is disposed on a cap (a part having the safety valve 16) which is fixed on the upper part of the outer can 17. However, when short-circuit is caused at the electrode 15 rather than at the lead 13 inside the battery and a temperature of the battery is increased by short-circuit current, increase of this short-circuit current can not be controlled.

When the short-circuit inside the lithium secondary battery increases a temperature, a polyethylene or polypropylene separator disposed between the positive electrode and the negative electrode is expected to have a function that the separator softens or melts to close holes thereon and release or confine a non-aqueous electrolyte contained therein to decrease its ion conductivity, and thereby reducing the short-circuit current.

But a separator away from the heating part does not always melt. Also, when a temperature further rises, the separator melts and is fluidized, and thereby the function to electrically insulate the positive electrode and the negative electrode is lost to cause short-circuit.

Besides, particularly in a lithium ion secondary battery, a negative electrode is formed by applying a slurry comprising a negative electrode active material such as graphite, a binder such as PVDF (poly(vinylidene fluoride)) and a solvent, onto a base substrate such as a copper foil which forms a collector, and drying it to form a thin film thereof. A positive electrode is constituted by forming a thin film of a positive electrode active material layer containing a positive electrode active material such as LiCoO₂, a binder and an electrically conductive assistant onto a base material such as an aluminum foil which forms a current collector in the same manner.

The electrically conductive assistant is used to increase an electronic conductivity at a positive electrode when the positive electrode active material has insufficient electronic conductivity. As the electronically conductive assistant, there is used carbon black (such as acetylene black) or graphite (such as artificial graphite KS-6 available form LONZA Co., Ltd.).

Such a battery has a problem that when a temperature of the battery increases to at least a temperature that a separator melts and is fluidized due to internal short-circuit or the like as mentioned above, large short-circuit current flows between a positive electrode and a negative electrode at an area where the separator is fluidized, and thus the temperature of the battery further increases due to the generation of heat, leading to further increase of short-circuit current.

Furthermore, when PTC device is disposed outside the battery, the space is occupied by the device, and there is a problem that the volume energy density is decreased and the structure of the battery become complicated.

The present invention has been carried out in order to solve the above problems. The object of the present invention is to secure safety, to control decrease of the volume energy density and further, to solve a problem such as the complication of a battery by providing a battery structure which can control the increase of short-circuit current even at temperature rise due to heat generation.

### DISCLOSURE OF INVENTION

The first battery of the present invention is obtained by sealing a battery body with an outer can, wherein at least one of a positive electrode and a negative electrode comprises an active material layer containing an active material and an electronically conductive material contacted to the active material, wherein the battery body has an electrolytic layer disposed between the positive and negative electrodes, wherein the electronically conductive material comprises an electrically conductive filler and a resin and resistance thereof is increased with temperature rise, and wherein the battery body is sealed with the outer can without forming extra space. According to this, the above electronically conductive material contains the electrically conductive filler and the resin to increase resistance thereof with temperature rise, and thus increase of current flowing through the electrode can be controlled when a temperature increases. Furthermore, since a function of increasing the resistance with temperature rise is present inside the battery, the battery can be sealed by using the battery body without forming extra space and thereby the volume energy density can be increased and the battery structure can be simplified as compared the battery with having the function outside the electrode.

The second battery of the present invention is characterized in that in the first battery, the resin contains a crystalline resin. According to this, by containing the crystalline resin in the resin, a rate of increase in resistance with temperature rise (namely, a changing ratio of resistance) can be improved, and there is obtained a battery capable of rapidly controlling increase of current flowing into the electrode.

The third battery of the present invention is characterized in that in the first battery, a melting point of the resin is in the range of 90° C. to 160° C. According to this, by using the resin having a melting point of 90° C. to 160° C., the electronically conductive material can increase a changing ratio of resistance at about a pre-determined temperature of 90° C. to 160° C., and thus characteristics of battery and safety can be coexistent with each other.

The fourth battery of the present invention is characterized in that in the first battery, 0.5 to 15 parts by weight of the electronically conductive material is contained in 100 parts by weight of the active material. According to this, by using the battery containing 0.5 to 15 parts by weight of the electronically conductive material in 100 parts by weight of the active material, resistance of the electrode before increase of a changing ratio of the electrode resistance against a temperature, and discharging capacitance can become desirable.

The fifth battery of the present invention is characterized in that in the first battery, an amount of the electrically conductive filler is 40 to 70 parts by weight in the electronically conductive material. According to this, by setting the amount of the electrically conductive filler to 40 to 70 parts by weight in the electronically conductive material, a changing ratio of resistance with temperature rise can be increased while normal resistance is low. Also, discharging capacitance of the battery can be increased.

The sixth battery of the present invention is characterized in that in the first battery, the electronically conductive material has a particle size of 0.05 μm to 100 μm. According to this, by using the electronically conductive material having a particle size of 0.05 μm to 100 μm, resistance of the electrode before increase of a changing ratio of resistance against a temperature and discharging capacitance can become desirable.

The seventh battery of the present invention is characterized in that in the first battery, a carbon material or an electrically conductive non-oxide is used as the electrically conductive filler. According to this, since the carbon material or the electrically conductive non-oxide is used as the electrically conductive filler, the electric conductivity of the electrode can be improved.

The eighth battery of the present invention is characterized in that in the first battery, the active material layer contains an electrically conductive assistant. According to this, since the electrode contains the electrically conductive assistant, resistance of the electrode can be suitably controlled even when the electronically conductive material having a small electronic conductivity is used.

The first process for preparing the battery of the present invention comprises the steps of:

(a) forming fine particles of the electronically conductive material by pulverizing an electronically conductive material comprising an electrically conductive filler and a resin,

(b) preparing an active material paste by dispersing the above fine particles of the electronically conductive material and the active material in a dispersion medium,

(c) forming an electrode by drying the above paste active material and by pressing it at a predetermined temperature T1 and a predetermined pressure,

(d) constituting a battery body by layering and laminating the above electrode and the electrolytic layer, and

(e) sealing the above outer can with an battery body without forming extra space.

According to this, since it comprises the steps (a) to (e), there can be prepared a battery in which the increase of current flowing through the electrodes is controlled when a temperature increases. Furthermore, since the function of increasing the resistance with temperature rise is present inside the battery, the battery can be sealed by using the outer can without forming extra space, and thereby the volume energy density can be increased and the battery structure can be simplified as compared with the battery having the function outside the electrode. Moreover, since this process includes the step (c), adhesion between the electronically conductive material and the active material becomes high and resistance of the produced electrode can be controlled into a low value.

The second process for preparing the battery of the present invention is characterized in that in the first process, the resin contains a crystalline resin. According to this, by containing the crystalline resin in the resin, a rate of increase in resistance to temperature rise (namely, a changing ratio of resistance) can be improved, and there is obtained a battery capable of rapidly controlling increase of current flowing into the electrode when a temperature is increased.

The third process for preparing the battery of the present invention is characterized in that in the first process, a predetermined temperature T1 is a melting point of the resin or a temperature near the melting point. According to this, by setting the predetermined temperature to the melting point of the resin or the temperature near the melting point, adhesion between the electronically conductive material and the active material is further improved and resistance of the produced electrode can be further decreased.

### BRIEF DESCRIPTION OF DRAWINGS

FIG. 1 is a typical sectional view illustrating the structure of a battery of the present invention,

FIG. 2 illustrates the relationship between each temperature and the value of maximum current in an external short-circuit current test at each temperature in Example 1,

FIG. 3 illustrates the relationship between each temperature and the value of maximum current in an internal short-circuit current test at each temperature in Example 1,

FIG. 4 is a plane view illustrating the state of a battery after sealing by using an aluminum laminating sheet in Example 1 and Comparative Example 1,

FIG. 5 is a cross sectional view illustrating the state of a battery after sealing by using an aluminum laminating sheet in Example 1 and Comparative Example 1,

FIG. 6 illustrates the relationship between each temperature and the value of maximum current in an internal short-circuit current test of Example 1,

FIG. 7 illustrates the relationship between an amount of an electronically conductive material and the resistance of the electrode and the relationship between an amount of the electronically conductive material and discharging capacitance of Example 2,

FIG. 8 illustrates the relationship between the particle size of the electronically conductive material and the volume specific resistance of the electrode and the relationship between the particle size of the electronically conductive material and discharging capacitance of Example 3,

FIG. 9 illustrates one example of a cylindrical battery, and

FIG. 10 illustrates a conventional battery in which a PTC device is used.

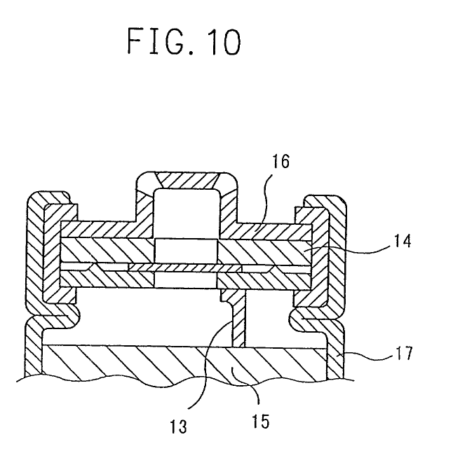

### BEST MODE FOR CARRYING OUT THE INVENTION

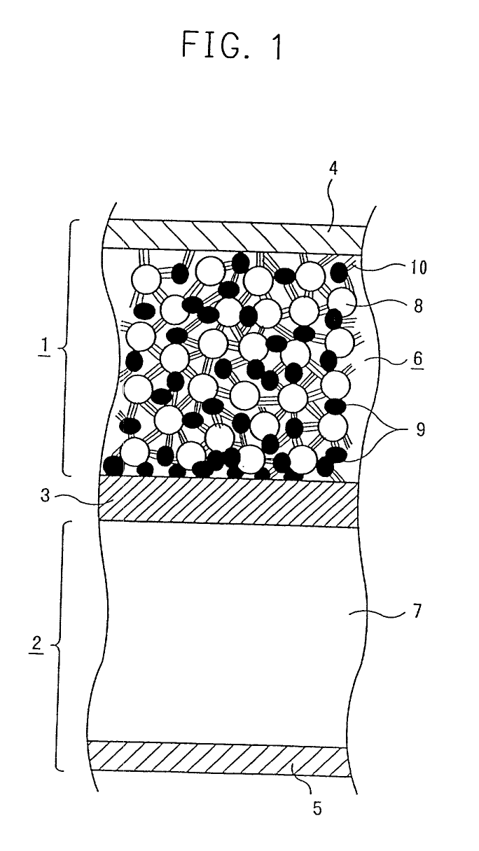

FIG. 1 is a sectional view illustrating the battery of the present invention, in particular, a longitudinal sectional view of the battery. In the figure, numeral 1 indicates a positive electrode in which the positive electrode active material layer 6 is formed on the surface of the positive electrode current collector 4, numeral 2 a negative electrode in which the negative electrode active material layer 7 is formed on the surface of the negative electrode current collector 5 and numeral 3 indicates an electrolytic layer such as a separator provided between the positive electrode 1 and the negative electrode 2, wherein the separator contains an electrolytic solution including lithium ions or the like. Also, in a solid electrolyte type lithium battery, a solid polymer having ionic conductivity is used, while in a gel electrolyte type lithium battery, a gel solid polymer having ionic conductivity is used.

The positive electrode active material layer 6 is obtained by bonding the positive electrode active material 8 and the electronically conductive material 9 with the binder 10 to mold it on the surface of the positive electrode current collector 4 comprising a metal film (for example an aluminum film). The electronically conductive material 9 comprises an electrically conductive filler and a resin or a crystalline resin, and has a property that a changing ratio of resistance against temperature is increased with temperature rise (hereinafter, the property is referred to as PTC (Positive Temperature Coefficient)).

The positive electrode active material 8 comprises particles. The electronically conductive material 9 is particles having a smaller size than that of the positive electrode active material 8. The size of the electronically conductive material 9 is preferably 0.05 μm to 100 μm, and the shape may be a fibrous or flaky small piece. Namely, the shape of the electronically conductive material 9 may be any shape having such a size that the electronically conductive material 9 can be disposed among the adjoining positive electrode active material 8.

In order to improve the following PTC properties (in order to increase the rate of change in resistance), it is preferable that the resin contains a crystalline resin.

The electronically conductive material 9 has a property that a rate of change in resistance is increased in a temperature range of, for example, 90° C. to 160° C.

The function of PTC is revealed because the resistance of the electronically conductive material 9 itself is increased due to softening, melting and volume expansion of the resin or the crystalline resin contained in the electronically conductive material 9.

As the electrically conductive filler, there can be used a carbon material, an electrically conductive non-oxide or the like. Examples of carbon material are carbon black such as acetylene black, furnace black, or lamp black; graphite; carbon fiber; and the like. Examples of the electrically conductive non-oxide are a metal carbide, a metal nitride, a metal silicide, a metal boride and the like. Examples of the metal carbide are TiC, ZrC, VC, NbC, TaC, Mo₂C, WC, B₄C, Cr₃C₂ and the like. Examples of the metal nitride are TiN, ZrN, VN, NbN, TaN, Cr₂N and the like. Examples of the metal boride are TiB₂, ZrB₂, NbB₂, TaB₂, CrB, MoB, WB and the like.

Moreover, the resin and the crystalline resin mean a polymer such as a high density polyethylene (a melting point of 130° C. to 140° C.), a low density polyethylene (a melting point of 110° C. to 112° C.), a polyurethane elastomer (a melting point of 140° C. to 160° C.) or poly(vinyl chloride) (a melting point of about 145° C.), whose melting points are in the range of 90° C. to 160° C.

In the electronically conductive material 9, a temperature of PTC expression depends on the melting point of the resin or the crystalline resin contained in the electronically conductive material 9. Thus, the temperature of PTC expression can be controlled in a range of 90° C. and 160° C. by changing a material of these resins.

PTC property may be a reversible property that resistance is returned to the original resistance when the temperature is lowered after expression of the PTC function, or may be irreversible property.

Though a temperature of PTC expression is preferably at most 90° C. from the viewpoint of safety guarantee, resistance at the electrode is increased at a temperature range in which a battery is usually used, and thus the battery performance such as load factor characteristics is lowered.

Also, when a temperature of PTC expression is more than 160° C., the inside temperature of the battery is increased to this temperature, which is not preferable from the viewpoint of safety guarantee. Therefore, in the electronically conductive material 9, it is desirable to set the temperature of PTC expression in a range of 90° C. to 160° C.

Since the temperature of PTC expression depends on the melting point of the resin or the crystalline resin, the resin or the crystalline resin having melting point of 90° C. to 160° C. is selected.

Also, in a usual condition, i.e. before PTC function is expressed, the resistance of the electrode can be adjusted by changing a ratio of the electronically conductive material 9 to the total of the positive electrode active material layer 6. And 0.5 to 15 parts by weight of the electronically conductive material 9 is preferably contained in 100 parts by weight of the active material.

Moreover, an amount of the electrically conductive filler in the electronically conductive material 9 is preferably 40 to 70 parts by weight from the viewpoint to increase the changing ratio of resistance at the electrode with temperature rise, to lower resistance in a usual condition and to increase the discharging capacitance of the battery.

As the positive electrode active material 8, it is possible to use a composite oxide of lithium and a transition metal such as cobalt, manganese or nickel; a chalcogen compound containing lithium; a composite compound thereof; a material in which various additional elements are added to the above composite oxide, chalcogen compound or composite compound; and various materials depending upon the sort of the battery.

The negative electrode active material layer 7 is obtained by forming a material obtained by bonding a negative electrode active material such as carbon particles with a binder and by molding it on the surface of the negative electrode current collector 5 comprising a metal film (a copper film, for example). As the negative electrode active material used for forming the negative electrode active material layer 7, it is possible to use a carbon material and the like, through which lithium ions can pass, and various materials depending upon the sort of the battery.

As the positive electrode current collector 4 and the negative electrode current collector 5, any metal stable in the battery is available. As the positive electrode current collector 4, aluminum can be preferably used, while as the negative electrode current collector 5, copper can be preferably used. As shape of each collector 4 and 5, any of foil, mesh, and expanded metal and the like can be used. Among those, shape having a large surface area such as mesh and expanded metal is preferable from the viewpoint to provide a jointing strength to the active material layer 6 or 7 and to easily impregnate the layer with an electrolytic solution after jointing.

As a material used for the separator 3, there can be used a material such as an insulating porous film, mesh or non-woven fabric to which an electrolytic solution can be impregnated, and which can provide a sufficient strength. Alternatively, in place of the separator 3, there can be used a polymer solid electrolyte, a gel solid electrolyte or the like having ionic conductivity. As the separator, a porous film comprising polypropylene, polyethylene or the like is preferably used from the viewpoint of guarantee of adhesion and safety. When a fluorine-containing resin is used, it is sometimes necessary to plasma-treat the surface thereof to guarantee adhesion.

In case of an organic electrolyte type lithium battery, as the electrolytic solution, there can be used solutions comprising a single or mixed solvent of an ether such as dimethoxyethane, diethoxyethane, dimethyl ether or diethyl ether or of an ester such as ethylene carbonate or propylene carbonate in which an electrolyte such as LiPF₆, LiClO₄, LiBF₄, LiCF₃SO₃, LiN(CF₃SO₂)₂ or LiC(CF₃SO₂)₃ is dissolved, or various electrolytic solutions depending on the sort of the battery.

In the positive electrode 1 as shown in FIG. 1, the electronically conductive material 9 itself contained in the positive electrode active material layer 6 has PTC properties, and thus when a temperature at the electronically conductive material 9 of the positive electrode 1 becomes higher than the temperature of PTC expression, resistance of the positive electrode active material layer 6 is increased.

Therefore, when an electrode (which is herein applied to a positive electrode) having such properties is applied to the battery, and in case when current is increased due to short-circuit outside or inside the battery and the temperature of the battery or the electrode is increased at least to some extent, resistance of the positive electrode active material layer 6 itself is increased, and thereby current flowing inside the battery is controlled.

Therefore, when the battery is formed by using this electrode, there are advantageous effects that safety of the battery is remarkably improved and is maintained even in an unusual situation such as short-circuit, reversed charge or overcharge.

FIG. 1 illustrated a case of the positive electrode active material layer 6 comprising the positive electrode active material 8, the electronically conductive material 9 and the binder 10 as an example, but it is not limited thereto. For example, when using such a material that the positive electrode active material 8 contained in the positive electrode active material layer 6 has low electronic conductivity, an additional electrically conductive assistant is added to the positive electrode active material layer 6 to supplement the low electronic conductivity.

There is disclosed a construction of the positive electrode 1, in particular, that of the electronically conductive material comprising the electrically conductive filler and the resin or the crystalline resin. However, it is not limited thereto, and a similar effect is also seen even when the above construction is applied to the negative electrode 2 to form a battery.

Hereinafter, there are explained processes for preparing the positive electrode 1 and the negative electrode 2 as shown in FIG. 1, and a battery using the positive electrode 1 and the negative electrode 2.

### Process for Preparing Positive Electrode

A pellet is prepared by mixing, in a predetermined ratio, an electronically conductive material such as fine particles of the electrically conductive filler and a resin or a crystalline resin, having sufficiently low volume specific resistance at a room temperature and high volume specific resistance at a temperature higher than a predetermined temperature of 90° C. to 160° C. Then, the pellet was finely pulverized to obtain fine particles of the electronically conductive material.

As a method of pulverizing the electronically conductive material, it is preferable to use compressed air or a compressed inert gas such as nitrogen or argon. In particular, in case of downsizing the particle size, the above gas is used to generate an ultrasonic air flow and the particles of the electronically conductive material are collided with each other or with wall surface (not shown in the figure) in the air flow to obtain an electronically conductive material having a smaller particle size (hereinafter, the method for preparing fine particles thereby is referred to as Jet Mill method).

Also, if the particle size of the fine particles of the electronically conductive material need not to be too small, there may be used a method of rotating the electronically conductive material in a ball mill for pulverization instead of using compressed air (this method for preparing fine particles is referred to as Ball Mill method).

Then, the fine particles of the electronically conductive material, the positive electrode active material (such as LiCoO₂), and the binder (such as PVDF) are dispersed in a dispersion medium (such as N-methylpyrolidone (hereinafter referred to as “NMP”)) to prepare a paste for the positive electrode active material.

Next, the above paste for the positive electrode active material is applied onto the current collector base substrate (such as a metal film having a predetermined thickness) which forms the positive electrode current collector 4.

Furthermore, after drying it, pressing is effected at a predetermined temperature with a predetermined surface pressure and the positive electrode active material layer 6 having a desirable thickness is formed to obtain the positive electrode 1.

According to the above-mentioned process for preparing the positive electrode 1, since the pressing is effected at a predetermined temperature with a predetermined surface pressure, adhesion between the electronically conductive material 9 and the active material (herein, the positive electrode active material 8) is improved and resistance of the electrode in a usual condition can be lowered.

That is, by controlling the temperature and the pressure (herein, surface pressure), resistance of the obtained electrode can be controlled. In particular, when the predetermined temperature is set to the melting point or about the melting point of the resin or the crystalline resin contained in the electronically conductive material, adhesion between the electronically conductive material 9 and the active material 8 is further improved and resistance of the electrode in a usual condition can be further lowered.

Herein, there has been illustrated a case where the positive electrode active material paste is pressed at the predetermined temperature with the predetermined surface pressure. However, the positive electrode 1 may be obtained by heating the positive electrode active material paste at a predetermined temperature (preferably, the melting point or a temperature near the melting point) after pressing the paste at a predetermined surface pressure.

Hereinafter, a process for preparing the negative electrode 2 is explained.

### Process for Preparing Negative Electrode

A negative electrode active material such as mesophase carbon microbeads (hereinafter referred to as “MCMB”) and PVDF are dispersed in NMP to prepare a paste for the negative electrode active material. Then, the paste is applied onto the metal film of a predetermined thickness which forms the negative electrode current collector to obtain the negative electrode 2 comprising the negative electrode active material layer 7.

Hereinafter, a process for preparing a battery is explained.

### Process for Preparing Battery

For example, a porous polypropylene sheet was interposed between the positive and negative electrodes which were prepared according to the above methods and the both electrodes were laminated together to obtain a battery body comprising the positive electrode and the negative electrode. Collector terminals were mounted to each of the positive and negative electrodes of the battery body, and the battery body was sealed with an outer can without forming extra space to prepare a battery. In the battery prepared according to the above process, safety of the battery itself is improved, because increase of short-circuit current can be controlled due to increase in resistance of the positive electrode with temperature rise, even when short-circuit happens outside or inside the battery to increase a temperature of the battery.

In the above preparation process, the electronically conductive material was contained in the positive electrode 1, but the electronically conductive material may be contained in the negative electrode 2 or in both of the positive electrode 1 and the negative electrode 2.

Hereinafter, more concrete examples of the present invention are illustrated. However, the present invention is not intended to be limited to these examples.

### EXAMPLE 1

### Process for Preparing Positive Electrode

Pellets of an electronically conductive material (comprising a mixture of 60 parts by weight of carbon black in the form of fine particles and 40 parts by weight of polyethylene) having volume specific resistance of 0.2 Ω·cm at a room temperature and volume specific resistance of 20 Ω·cm at 135° C. were finely pulverized according to Jet Mill method to obtain fine particles of the electronically conductive material.

Then, 6 parts by weight of the electronically conductive material in the form of fine particles, 91 parts by weight of a positive electrode active material (LiCoO₂), and 3 parts by weight of a binder (PVDF) were dispersed in NMP as a dispersion medium to obtain a paste for the positive electrode active material.

Then, the above positive electrode active material paste was applied onto the positive electrode current collector 4 comprising a metal film (herein an aluminum foil) having a thickness of 20 μm according to Doctor Blade method. Furthermore, it was dried at 80° C., and was pressed at a room temperature with a surface pressure of 2 ton/cm² to form a positive electrode active material layer 6 having a thickness of approximately 100 μm to obtain the positive electrode 1.

### Process for Preparing Negative Electrode

A paste for the negative electrode active material was prepared by dispersing 90 parts by weight of MCMB and 10 parts by weight of PVDF in NMP. The paste was applied onto a negative electrode current collector comprising a copper foil having a thickness of 20 μm according to Doctor Blade method to prepare the negative electrode 2 comprising the negative electrode active material layer 7.

### Process for Preparing Battery

A porous polypropylene sheet (available from Höchst Co., Ltd.; Trade-name: CELLGUARD#2400) was interposed between the positive and negative electrodes prepared according to the above method, and the both electrodes were laminated to prepare a battery body comprising the positive electrode and the negative electrode. The collector terminals were mounted to each of the positive and negative electrodes of the battery body, and it was sealed with an outer can comprising an aluminum-laminating sheet and the like without forming extra space to prepare a battery.

### Evaluation of Electrodes and Battery

In order to evaluate the electrodes and the battery of the present invention, the following manners were employed:

### Measurement of Electrode Resistance

Aluminum foil was fused on both surfaces of the produced electrodes. Then, the plus-side voltage terminal and plus-side current terminal were connected onto one surface of one aluminum foil, while the minus-side voltage terminal and minus-side current terminal were connected onto the other aluminum foil. A heater was connected to the terminals, and by increasing a temperature of the electrode at a ratio of 5° C./min, voltage drop of the device through which a constant current was flowed was measured, and resistance was measured (herein volume specific resistance (Ω·cm)).

### Capacitance Test

Both of the prepared positive and negative electrodes were cut into a part having size of 14 mm×14 mm, and a porous polypropylene sheet (available from Höchst Co., Ltd.; Trade-name: CELLGUARD #2400) was interposed between both electrodes the both electrodes were laminated to prepare a battery body. The current collector terminals were mounted to each of the positive and negative electrodes of the battery body by spot-welding. The battery body was inserted into a bag made of an aluminum-laminated sheet. Thereto was added an electrolytic solution which was obtained by dissolving lithium hexafluorophosphate in a mixed solvent of ethylene carbonate and diethyl carbonate (in a molar ratio of 1:1) in a concentration of 1.0 mol/dm³. Then, the bag was sealed by thermal fusing to prepare a simple battery. Width of the sealed part by the aluminum-laminated sheet was 3 mm. A charge-discharge test for this battery was carried out at a room temperature.

### External and Internal Short-Circuit Test

The prepared electrodes were cut into a part having size of 14 mm×14 mm, and a porous polypropylene sheet (available from Höchst Co., Ltd.; Trade-name: CELLGUARD #2400) was interposed between the positive and negative electrodes, and the both electrodes were laminated to prepare a bare battery. A plurality of the bare batteries was prepared and current collector terminals were connected to each edge of the positive and negative electrode current collector of the bare battery. Then, the positive electrode current collector terminals were connected to each other and the negative electrode collector terminals were also connected to each other by spot welding, and each bare battery was connected in electrically parallel to form a battery body.

This battery body was inserted into a bag made of an aluminum-laminated sheet, Thereto was added an electrolytic solution in which 1.0 mol/dm³ of lithium hexafluorophosphate was dissolved in a mixed solvent of ethylene carbonate and diethyl carbonate (in a molar ratio of 1:1). Then, the bag was sealed by thermal fusing to prepare a battery. At this time, the current collector terminals were thermally fused with an aluminum-laminated sheet and were put out to the outside of the battery.

In case of external short-circuit test, the battery was charged at a room temperature into 4.1 V at 8.0 mA. After charging, a temperature of the battery was gradually increased from a room temperature. And the current collector terminals of the positive and negative electrodes put out to the outside of the battery were connected to each other at a predetermined temperature, thus the positive electrode and negative electrodes were short-circuited outside the battery, and the current value at that point was measured.

In case of internal short-circuit test, the battery was charged at a room temperature into 4.1 V at 8.0 mA. After charging, a temperature of the battery was gradually elevated from a room temperature. And the current collectors of the positive and negative electrodes were short-circuited at a predetermined temperature without using any collector terminal, and then the current value at the point was measured.

### COMPARATIVE EXAMPLE 1

For comparison, artificial graphite KS-6 (available from LONZA Co., Ltd.) was used as an electronically conductive material. And 6 parts by weight of the artificial graphite KS-6 in the form of fine particles, 91 parts by weight of a positive electrode active material (LiCoO₂) and 3 parts by weight of a binder (PVDF) were dispersed in NMP as a dispersion medium to obtain a positive electrode active material paste. Then, this positive electrode active material paste was applied onto a metal film (herein an aluminum foil) having a thickness of 20 μm which forms the positive electrode current collector 4 according to Doctor Blade method. Furthermore, it was dried at 80° C., and was pressed at a room temperature with a surface pressure of 2 ton/cm² to form the positive electrode active material layer 6 having a thickness of approximately 100 μm to obtain a positive electrode. The positive electrode was connected to a current collector terminal through the electronically conductive material used in Example 1. By using the positive electrode to which the collector terminal was connected, a battery was prepared in the same manner of preparing the negative electrode and the battery as in Example 1. Then, evaluation of the electrodes and the battery was made in the same manners as in Example 1.

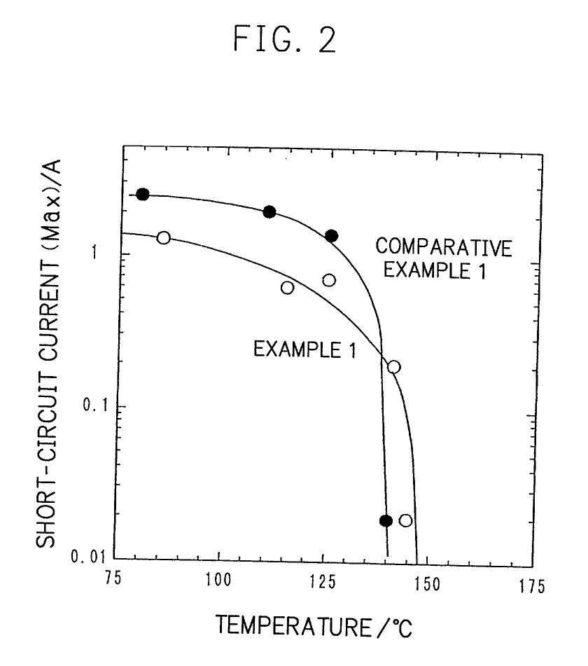

FIG. 2 illustrates the relationship between each temperature and the value of maximum current in the external short-circuit current test for the battery in Example 1 and Comparative Example 1.

As shown in the figure, it is found that according to the external short-circuit current test, in both Example 1 and Comparative Example 1, resistance is remarkably changed, thus the function of PTC is revealed similarly to the case where PTC device is mounted on the external area of the battery.

In Example 1, since the crystalline resin is contained in the electrode, particularly in the electronically conductive material of the positive electrode active material layer, when the temperature inside the battery becomes higher than a predetermined temperature, the function of PTC is revealed, and the increase of short-circuit current can be inhibited before the temperature of the battery becomes higher than 160° C., and thus safety and reliability of the battery are improved.

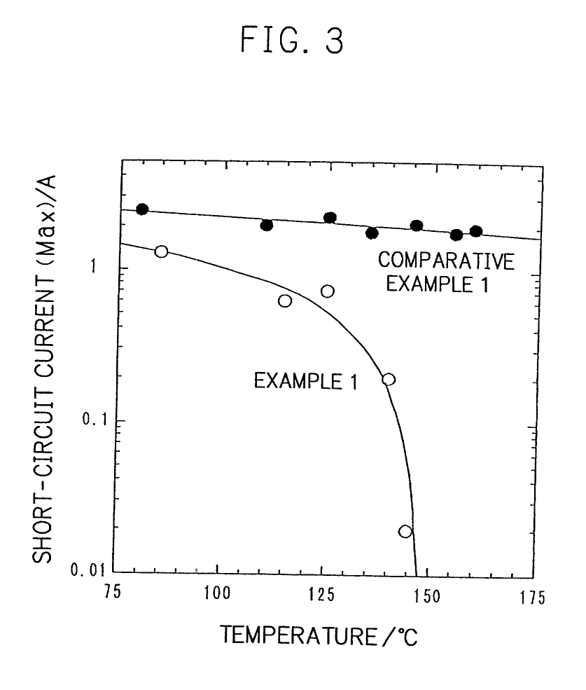

FIG. 3 illustrates the relationship between each temperature and the value of maximum current in the internal short-circuit current test for the battery in Example 1 and Comparative Example 1.

As shown in the figure, the PTC function of the battery in Example 1 is revealed when the internal short-circuit test is carried out at a temperature of at least 120° C., and therefore, the maximum short-circuit current became smaller than those at a temperature of at most 120° C. However, in the battery of Comparative Example 1, since the PTC device is out of a short-circuit route, even when the battery is short-circuited at a temperature of at least 120° C., the function of PTC is not revealed, and thus decrease of short-circuit current is not observed. As described above, with respect to internal short-circuit, even when a PTC device is mounted outside an electrode, advantageous effects can not be observed, and safety can not be improved unless the electrode is provided with the PTC function.

Moreover, when an electrode is provided with PTC function, it is not necessary to provide the PTC function outside the electrode, and thus there are expected an effect of simplification of battery structure and volume energy density improvement since the space occupied by the PTC device is not necessary.

Table 1 shows characteristics of the battery in Example 1, together with those in Comparative Example 1, in particular, volume specific resistance of the electrode, a changing ratio of the volume specific resistance, and discharging capacitance of the battery.

In Table 1, the changing ratio of resistance means the value which is obtained by dividing the volume specific resistance after PTC expression by the one before PTC expression.

TABLE 1

| | Volume specific | | Discharging |
|---|---|---|---|
| | resistance | Changing ratio | capacitance |
| | (Ω · cm) | of resistance | (mAh) |
| Ex. 1 | 100 | 50 | 4.3 |
| Com. | 60 | 1.1 | 4.3 |
| Ex. 1 | | | |

It is found that in Example 1, since the crystalline resin is contained in the electrode, particularly in the electronically conductive material of the positive electrode active material layer of the positive electrode, the resistance after PTC expression is increased as fifty times as larger than that before PTC expression. On the other hand, in Comparative Example 1, the changing ratio of resistance is small.

Therefore, when a battery is constituted by using the electrode in Example 1, PTC function is revealed when a temperature inside the battery becomes higher than the predetermined temperature, increase of short-circuit current can be inhibited, and then safety and reliability of the battery itself is improved.

In Example 1, the battery having 50 of the changing ratio of resistance was shown. However, it is not intended to be limited thereto. The above effect can be obtained when the changing ratio of resistance is approximately 1.5 to 10000.

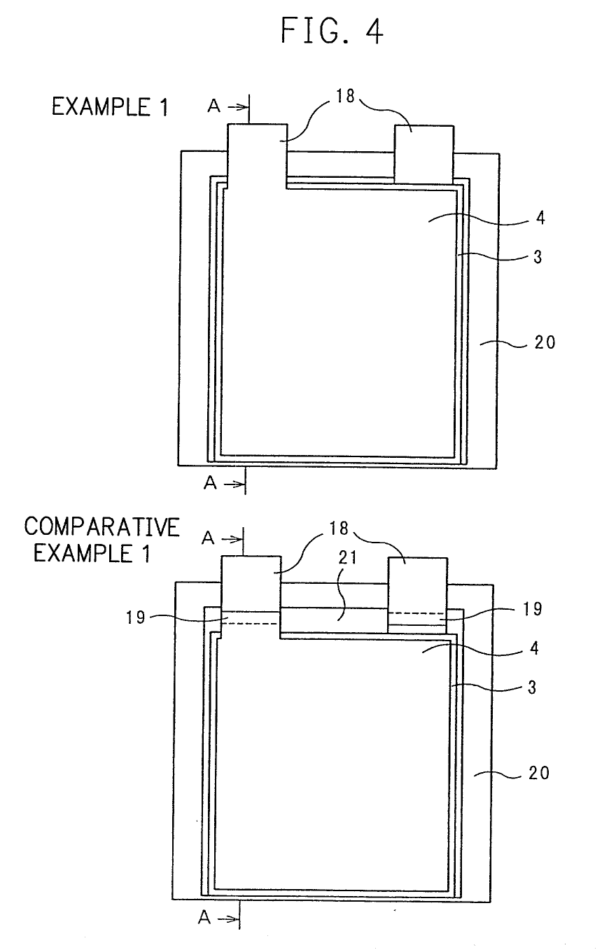

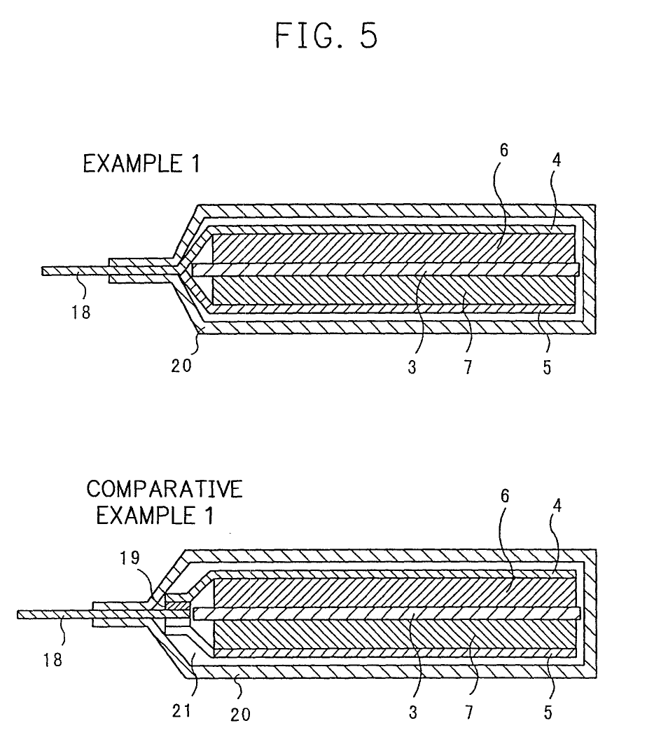

FIG. 4 illustrates states of the batteries in Example 1 and Comparative Example 1 after sealing with an aluminum laminated sheet, i.e., plan views showing the insides of the batteries after the upper side of the sheet is removed. FIG. 5 shows a cross sectional view illustrating states of the batteries in Example 1 and Comparative Example 1 after sealing with an aluminum laminated sheet, i.e., a cross sectional view taken on line “A-A” in FIG. 4. In the figure, numeral 18 indicates a collector terminal, numeral 19 a PTC device, numeral 20 an outer can comprising an aluminum laminated sheet, and numeral 21 an extra space area. The shape of the battery in Example 1 is 20 mm×20 mm with a thickness of 0.5 mm, while that of Comparative Example 1 is 23 mm×20 mm with a thickness 0.5 mm. Since the PTC device 19 is mounted outside the electrode in Comparative Example 1, the extra space area 21 is formed, and thus the volume of the battery is increased. Also, as compared with Example 1, the number of parts is increased and the structure of the battery is complicated. In Table 2, discharging capacitance, volume of the battery, and volume energy density in Example 1 are compared with that of Comparative Example 1. It is found that, in Comparative Example 1, the discharging capacitance is the same as the one in Example 1, however, since the PTC device is mounted outside the electrode of Comparative Example 1, the volume of the battery become larger, and consequently, the volume energy density is decreased.

TABLE 2

| | Discharging | | |
|---|---|---|---|
| | capacitance | Volume of | Volume energy |
| | (mAh) | battery (cm³) | density (mAh/cm³) |
| Ex. 1 | 4.3 | 0.20 | 21.5 |
| Com. | 4.3 | 0.23 | 18.7 |
| Ex. 1 | | | |

### COMPARATIVE EXAMPLE 2

As the electronically conductive material 9, pellets of a mixture of 60 parts by weight of carbon black in the form of fine particles and 40 parts by weight of a polypropylene resin (a melting point of 168° C.) were finely pulverized according to Jet Mill method to obtain fine particles of the electronically conductive material. Then, a positive electrode was formed in the same manner as in Example 1 except for the above. By using this positive electrode, a battery was prepared and the battery and the electrode were evaluated in the same manner as in Example 1.

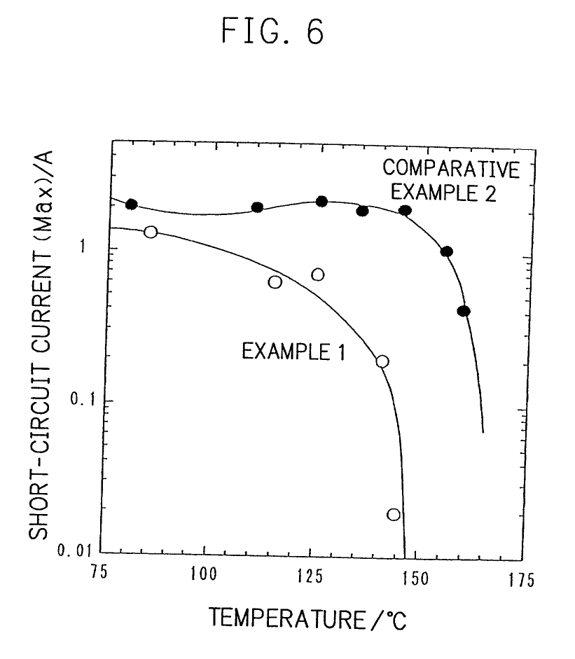

FIG. 6 illustrates the relationship between each temperature and the value of maximum current in short-circuit current test for the battery of Example 1 and Comparative Example 2.

As shown in the figure, in Comparative Example 2, a temperature of PTC expression was higher than 160° C. With respect to this result, it is considered that because the polypropylene resin having a melting point of 168° C. was used as the crystalline resin, when the electrode containing the polypropylene resin was applied to the battery, a temperature of PTC expression became higher than 160° C.

On the other hand, in Example 1, polyethylene having a melting point lower than 160° C. was used as the crystalline resin, and thus increase of short-circuit current was inhibited before the temperature exceeded 160° C., and safety and reliability of the battery are further improved.

As mentioned above, PTC effect functions at not less than 120° C. to decrease short-circuit current, while in the battery of Comparative Example 2, a temperature of PTC expression is higher, and decrease of short-circuit current can be confirmed only after the temperature becomes at least 160° C. This is because the melting point of the crystalline resin (herein polypropylene) contained in the electronically conductive material is higher.

Therefore, if the crystalline resin having a melting point of 90° C. to 160° C. is selected as the crystalline resin contained in the electronically conductive material 9, the performance of the battery is not decreased and the PTC expression temperature can be lower than 160° C.

### COMPARATIVE EXAMPLE 3

As an electronically conductive material, pellets of a mixture of 38 parts by weight of carbon black and 62 parts by weight of polyethylene were finely pulverized according to Jet Mill method to obtain fine particles of the electronically conductive material. Then, a positive electrode was formed in the same manner as in Example 1 except for the above. By using this positive electrode, a battery was prepared in the same manner as in Example 1.

### COMPARATIVE EXAMPLE 4

As an electronically conductive material, pellets of a mixture of 71 parts by weight of carbon black and 29 parts by weight of polyethylene were finely pulverized according to Jet Mill method to obtain fine particles of the electronically conductive material. Then, a positive electrode was formed in the same manner as in Example 1 except for the above. By using this positive electrode, a battery was prepared in the same manner as in Example 1.

Table 3 shows volume specific resistance of the electrode, a changing ratio of resistance with temperature rise, value of discharging capacitance at 2C (C: time rate) of the battery and maximum short-circuit current value at 140° C., comparing Example 1 with Comparative Examples 3 and 4.

TABLE 3

| | | Changing ratio | | Maximum |
|---|---|---|---|---|
| | Volume specific | of resistance at | Discharging | short-circuit |
| | resistance | temperature | capacitance | current at |
| | (Ω · cm) | rise | (mAh) | 140° C. (mA) |
| Ex. 1 | 100 | 50 | 4.3 | 0.20 |
| Com. | 521 | 112 | 1.1 | 0.15 |
| Ex. 3 | | | | |
| Com. | 62 | 1.7 | 4.3 | 2.4 |
| Ex. 4 | | | | |

As shown in Table 3, the changing ratio of resistance is larger, resistance of the electrode is higher and discharging capacitance is lower in Comparative Example 3 than those in Example 1.

Furthermore, in Comparative Example 4, while discharging capacitance is higher than in Example 1, the PTC function is insufficient due to a high ratio of the carbon black, and thus decrease of short-circuit current was not observed in short-circuit test.

Therefore, by changing the ratio of the electrically conductive filler contained in the electronically conductive material, the changing ratio of resistance of the electrode and discharging capacitance of the battery can be adjusted to a suitable value.

In particular, by setting the amount of the electrically conductive filler contained in the electrode to 40 to 70 parts by weight, resistance of the electrode in a usual condition (namely, before PTC expression) can be lowered, the changing ratio of resistance of the electrode can be increased, and furthermore, the discharging capacitance can be increased when this electrode is used to constitute a battery.

Moreover, by setting the amount of the electrically conductive filler contained in the battery to 50 to 68 parts by weight, characteristics of the electrode and the battery shown in Table 3 can be more preferable.

### EXAMPLE 2

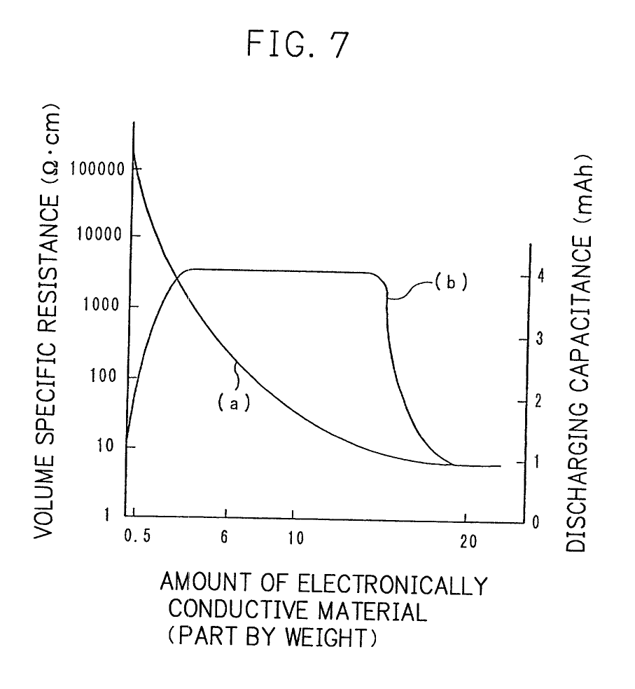

The ratio of the electronically conductive material in preparation of the positive electrode in Example 1 was varied. FIG. 7 illustrates the relationship between the ratio of the electronically conductive material and volume specific resistance of the electrode and the relationship between the ratio of the electronically conductive material and discharging capacitance. Specifically, it illustrates the relationship between the ratio of the electronically conductive material based on 100 parts by weight of the total solid content of the electrode (herein the positive electrode) of the battery and volume specific resistance ((a) in the figure) of the electrode, and the relationship between the ratio of the electronically conductive material based on 100 parts by weight of the total solid content of the electrode (herein the positive electrode) of the battery and discharging capacitance ((b) in the figure).

As shown in the figure, when at most 0.5 part by weight of the electronically conductive material is used, usual resistance of the electrode becomes too high, discharging capacitance becomes small and there are problems in battery performance. Also, when at least 15 parts by weight thereof is used, an amount of the active material is decreased, and thereby discharging capacitance becomes small.

Therefore, by setting the amount of the electronically conductive material to 0.5 to 15 parts by weight based on 100 parts by weight of the total solid content of the electrode, usual resistance of the electrode can be lowered and discharging capacitance of the battery using this electrode can be increased. More preferably, by setting to 0.7 to 12 parts by weight, most preferably, 1 to 10 parts by weight of the electronically conductive material, a further desirable battery can be prepared.

### EXAMPLE 3

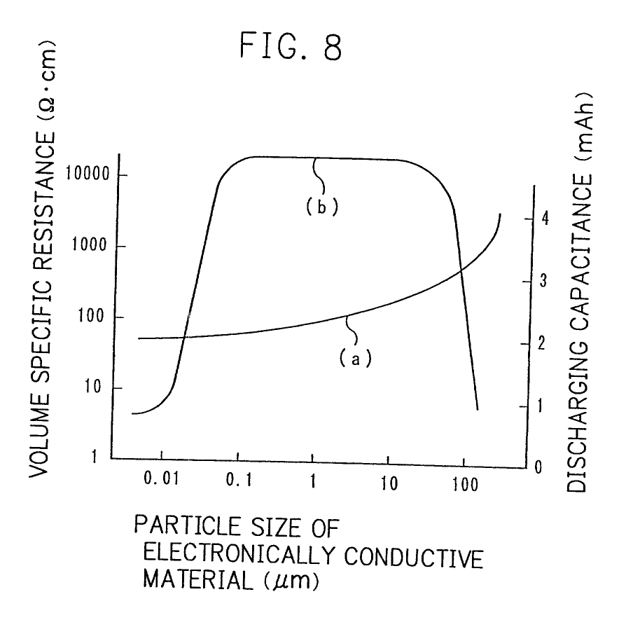

Particle size of the electronically conductive material in preparation of the positive electrode in Example 1 was varied. FIG. 8 illustrates the relationship between the particle size of the electronically conductive material and the resistance of the electrode ((a) in the figure) and the relationship between particle size of the electronically conductive material and the discharging capacitance ((b) in the figure).

When the particle size of the electronically conductive material is at most 0.05 μm, a filling ratio of the electronically conductive material is decreased, which means that volume of the electronically conductive material per a unit volume of the positive electrode active material layer is increased, namely that an amount of the positive electrode active material is decreased. Therefore, when the particle size of the electronically conductive material is at most 0.05 μm, discharging capacitance is decreased. On the other hand, when the particle size of the electronically conductive material is at least 100 μm, resistance of the electrode itself is increased and discharging capacitance is decreased.

Accordingly, by setting the average particle size of the electronically conductive material to 0.05 to 100 μm, usual resistance of the electrode can be lowered and discharging capacitance can be increased. Preferably, by setting the average particle size of the electronically conductive material to 0.1 to 50 μm, more preferably, 0.5 to 20 μm, volume fraction of the electronically conductive material, volume specific resistance of the electrode itself, and discharging capacitance can be further desirably improved.

### EXAMPLE 4

Pellets of an electronically conductive material (prepared by mixing 60 parts by weight of carbon black in the form of fine particles and 40 parts by weight of polyethylene) having volume specific resistance of 0.2 Ω·cm at a room temperature and volume specific resistance of 20 Ω·cm at 135° C. were finely pulverized by using Ball Mill to obtain fine particles of the electronically conductive material.

By using the fine particles of the electronically conductive material, an electrode (herein a positive electrode) was prepared in the same manner as in Example 1, and furthermore, a battery was prepared in the same manner of preparing the negative electrode and the battery as in Example 1.

Table 4 shows the average particle size of the electronically conductive material, resistance of each electrode, and discharging capacitance.

TABLE 4

| | Average particle size | Volume specific | Discharging |
|---|---|---|---|
| | of electronically | resistance | capacitance |
| | conductive material (μm) | (Ω · cm) | (mAh) |
| Ex. 1 | 9.1 | 100 | 4.3 |
| Ex. 4 | 52.3 | 932 | 2.8 |

In this example, since the electronically conductive material was pulverized according to Ball Mill method, the average particle size of the obtained electronically conductive material particles become larger. As a result, volume specific resistance is increased and discharging capacitance is decreased, but the battery can be used in practice.

As the results show, it is found that in order to achieve lower usual resistance of the electrode and higher discharging capacitance of the battery, it is preferable to pulverize the electronically conductive material according to Jet Mill method.

### EXAMPLE 5

Example 5 is characterized in that in Example 1, the positive electrode active material paste was applied onto an aluminum foil, dried at 80° C., and thereafter pressed at 135° C. with a pressure of 0.5 ton/cm² for 30 minutes to prepare an electrode (herein a positive electrode). In this example, the preparation methods of the negative electrode and the battery are the same as those in Example 1.

Table 5 shows characteristics of the electrode and the battery of Example 5, together with those of Example 1.

TABLE 5

| | Porosity | Volume specific | Discharging |
|---|---|---|---|
| | (%) | Resistance (Ω · cm) | capacitance (mAh) |
| Ex. 1 | 30 | 100 | 4.3 |
| Ex. 5 | 25 | 87 | 4.3 |

As shown in Table 5, since the dried positive electrode active material paste was pressed at a temperature near the melting point of the crystalline resin contained in the electronically conductive material in this example, adhesion between the electronically conductive material and the active material is improved. Therefore, resistance of the electrode in a usual condition can be controlled to a low value.

This means that by controlling the temperature or the pressure (herein the surface pressure) in pressing the dried positive electrode active material paste, the resistance of the obtained electrode can be controlled.

In particular, by setting the temperature of pressing the dried positive electrode active material paste to the melting point or near the melting point of the crystalline resin contained in the electronically conductive material, volume specific resistance of the obtained electrode in a usual condition can be small even if the pressure is lowered to some extent since the paste is pressed at a temperature near the melting point of the crystalline resin.

### EXAMPLE 6

### Process for Preparing Positive Electrode

Pellets of an electronically conductive material (prepared by mixing carbon black and polyethylene in a predetermined ratio) having volume specific resistance of 0.2 Ω·cm at a room temperature and volume specific resistance of 500 Ω·cm at an operating temperature of 135° C. were finely pulverized according to Jet Mill to obtain fine particles having an average particle size of 9.0 μm.

A mixture of 4.5 parts by weight of the fine particles of the electronically conductive material, 1.5 parts by weight of artificial graphite KS-6 (available from LONZA Co., Ltd.) as an electrically conductive assistant, 91 parts by weight of an active material (LiCoO₂) and 3 parts by weight of a binder (PVDF) was dispersed in NMP as a dispersion medium to obtain a paste for the positive electrode active material.

Then, the above positive electrode active material paste was applied onto a metal film (herein an aluminum foil) having a thickness of 20 μm which forms the positive electrode current collector 4, according to Doctor Blade method. Then, it was dried at 80° C., pressed at a predetermined temperature at a room temperature with a predetermined surface pressure of 2 ton/cm² to form the positive electrode active material layer 6 having a thickness of approximately 100 μm, and the positive electrode 1 was obtained. Preparation methods of the negative electrode and a battery are the same as in Example 1.

Table 6 shows characteristics of the electrode and the battery of Example 6 and those of Example 1. Specifically, there are shown volume specific resistance, a changing ratio of resistance and discharging capacitance of each electrode.

TABLE 6

| | Volume specific | Discharging | Maximum |
|---|---|---|---|
| | resistance | capacitance | short-circuit current |
| | (Ω · cm) | (mAh) | at 140° C. (mA) |
| Ex. 1 | 100 | 4.3 | 0.20 |
| Ex. 6 | 81 | 4.3 | 0.25 |

As compared with Example 1, both the resistance and the changing ratio of resistance of the electrode in Example 6 show almost similar value as in Example 1.

Namely, even if an electronically conductive material having high volume specific resistance is used, volume specific resistance of the electrode in a usual condition can be lowered and discharging capacitance can be improved by adding an electrically conductive assistant.

Herein, as the electrically conductive assistant, graphite (herein artificial graphite KS-6 (available from LONZA Co., Ltd.)) was used. However, the assistant is not limited thereto. The electrically conductive assistant may be any material having no PTC function but having a function of improving electric conductivity of the positive electrode active material layer, for example, carbon black such as acetylene black or lump black.

Additionally, the electrode and the battery shown in the above examples can be used not only for a lithium secondary battery of an organic electrolytic solution type, a solid electrolytic type, and a gel electrolytic type, but also for a primary battery such as a lithium/manganese dioxide battery or for another secondary battery.

Furthermore, the above electrode and the battery are useful for an aqueous-solution primary and secondary battery. These electrode and battery can be further used for a primary and secondary battery of a laminated type, a winding type, a button type and the like.

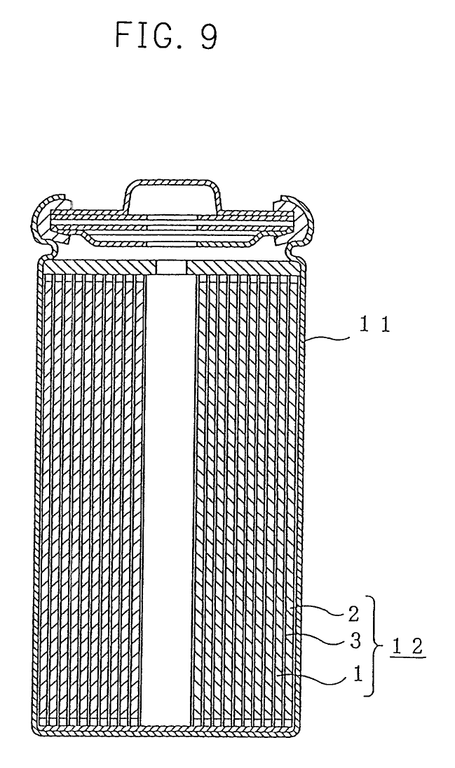

FIG. 9 is a typical cross sectional view illustrating a structure of a cylindrical lithium ion secondary battery. In the figure, numeral 11 indicates an outer can made of stainless or the like, which also functions as a negative electrode terminal, numeral 12 indicates a battery body contained inside the outer can 11. The battery body 12 has such a structure that the positive electrode 1, the separator 3 and the negative electrode 2 are wound in a spiral shape, and the positive electrode 1 of the battery body 12 has the structure of any electrode described in Examples 1 to 6.

Also, the structure may be such that the negative electrode active material layer of the negative electrode 2 has the electronically conductive material containing the crystalline resin and the electrically conductive filler.

### INDUSTRIAL APPLICABILITY

The battery and the process for preparing the same of the present invention can be applied not only to a lithium ion secondary battery of an organic electrolytic solution type, a solid electrolyte type, and a gel electrolyte type, but also to a primary battery such as a lithium/manganese dioxide battery or another secondary battery.

Furthermore, the battery and the process for preparing the same of the present invention can be applied also to an aqueous-solution primary and secondary battery, and a primary and secondary battery of a laminated type, a winding type, a button type and the like.

1. A battery obtained by sealing a battery body with an outer can, wherein at least one of a positive electrode and a negative electrode comprises an active material layer containing an active material and an electronically conductive material contacted to the active material, and the battery body has an electrolytic layer between the above positive and negative electrodes,
wherein the electronically conductive material comprises an electrically conductive filler and a resin, and resistance thereof is increased with temperature rise,
and wherein the battery body is sealed with the outer can without forming extra space.

2. A battery according to claim 1, wherein the resin contains a crystalline resin.

3. A battery according to claim 1, wherein the melting point of the resin is in the range of 90° C. to 160° C.

4. A battery according to claim 1, wherein 0.5 to 15 parts by weight of the electronically conductive material is contained in 100 parts by weight of the active material.

5. A battery according to claim 1, wherein an amount of the electrically conductive filler is 40 to 70 parts by weight in the electronically conductive material.

6. A battery according to claim 1, wherein the electronically conductive material has the particle size of 0.05 μm to 100 μm.

7. A battery according to claim 1, wherein the carbon material or the electrically conductive non-oxide is used as the electrically conductive filler.

8. A battery according to claim 1, wherein the active material layer contains an electrically conductive assistant.

9. A process for preparing a battery comprising the steps of:
(a) forming fine particles of the electronically conductive material by pulverizing the electronically conductive material comprising the electrically conductive filler and a resin,
(b) preparing a paste for an active material by dispersing the above fine particles of the electronically conductive material and the active material in a dispersion medium,
(c) forming an electrode by drying the above paste active material and by pressing it at a predetermined temperature T1 and a predetermined pressure,
(d) forming a battery body by layering and laminating the above electrode and the electrolytic layer, and
(e) sealing the above battery body with the outer can without forming extra space.

10. A process for preparing a battery according to claim 9, wherein the resin contains a crystalline resin.

11. A process for preparing a battery according to claim 9, wherein the predetermined temperature T1 is the melting point of the resin or the temperature near the melting point.
